(19) United States
(12) Patent Application Publication
(10) Pub. No.: US 2016/0169711 A1
(43) Pub. Date: Jun. 16, 2016

(54) Fiber optic sensor cable and fiber optic sensing system

(71) Applicant: OFS Fitel, LLC, Norcross, GA (US)

(72) Inventors: Robert J. Blakley, Bristol, CT (US); Jacob Ulrik Petersen, Tune (DK)

(21) Appl. No.: 14/872,736

(22) Filed: Oct. 1, 2015

Related U.S. Application Data
(60) Provisional application No. 62/058,862, filed on Oct. 2, 2014.

(51) Int. Cl. G01D 5/353; G01K 11/32; G02B 6/44

(52) U.S. Cl. CPC G01D 5/353; G02B 6/4415; G02B 6/4433; G01K 11/3206

(57) ABSTRACT

The present disclosure relates to a fiber optic sensor cable comprising one or more optical fibers, each optical fiber comprising at least one core for guiding light, at least one cladding layer and one or more coating layers, at least one (thermoplastic) buffer layer surrounding each optical fiber, two or more longitudinally extending strength members located on opposite sides of the buffer layer(s), and a plastic jacket enveloping the buffer layer(s) and the strength members. A further embodiment relates to a remote sensing system incorporating one or more of said fiber optic sensor cables.

### BACKGROUND OF INVENTION

Flexible tubes and flexible pipes are widespread used for transport of liquids and fluids, for example in the oil industry for transport of oil or gas between a (floating) offshore installation to a permanently anchored storage rig. It is desirable to be able to monitor stress, strain, pressure and temperature of the flexible tubes, however the often harsh conditions makes it impossible to use traditional electrical or RF based sensors. Optical fibers are known for use as stress and temperature sensors, however it is not straightforward to integrate a fragile optical fiber in a steel armored flexible oil tube. One way to protect optical fibers is to encapsulate the optical fiber in a hermetically sealed metal tube, a concept known as fiber in metal tube (FIMT). This rugged construction can be effective for protecting against hydrostatic pressures, high temperature effects and corrosive environments. FIMT are therefore often applied in for example down-hole fiber optic sensing applications.

However in flexible tubes the FIMT has limitations, because the FIMT construction is not flexible and bending a FIMT construction might impose stress to (or break) the encapsulated fiber making it useless for stress sensing applications. The FIMT construction furthermore has a relatively high weight per unit length and is difficult to handle in the lengths that are necessary for incorporating the sensor cable into a flexible oil tube for an offshore installation.

### SUMMARY OF INVENTION

The present disclosure relates to a fiber optic sensor cable addressing the above mentioned limitations. A first embodiment relates to a fiber optic sensor cable comprising one or more optical fibers, each optical fiber comprising at least one core for guiding light, at least one cladding layer and one or more coating layers, at least one buffer layer, preferably a thermoplastic buffer layer, surrounding each optical fiber, two or more longitudinally extending strength members located on opposite sides of the buffer layer(s), and a plastic jacket enveloping the buffer layer(s) and the strength members. The plastic jacket is preferably a thermoplastic jacket, such as a PVDF jacket. In the preferred embodiment the cross-section of the thermoplastic jacket has a generally rectangular shape. Furthermore, the strength members are preferably metallic.

The buffer layer surrounding an optical fiber may form a tight or a semi-tight buffer layer.

The purpose of this is that the fiber optic sensor cable is configured such that each optical fiber is disposed and/or arranged in a stress-free configuration in the buffer layer.

The presently disclosed fiber optic sensor cable may have the strength of the FIMT construction, for example if the longitudinal strength members are metal wires. Appropriate selection of buffer and jacket material may also provide the same rugged properties as provided by FIMT such that the presently claimed sensor cable can withstand harsh chemical and mechanical environments and high temperatures. But the major advantage of the presently disclosed fiber optic sensor cable is that the construction can be made kink-free. With appropriate arrangement of the optical fiber(s) and the longitudinal strength members in the jacket, the sensor cable can be made substantially flexible towards bending in one direction and substantially resistant towards bending in the opposite direction. I.e. the sensor cable provides for a stress free configuration of the optical fiber(s) along with sufficient strength and low weight per meter along with a flexibility and rigidity that makes handling easy and opens for easy incorporation into a flexible tube, also in the form of a steel armored flexible oil tube, because the fiber optic sensor cable can be fully manufactured and reeled prior to incorporation in a flexible pipe or tube.

### BRIEF DESCRIPTION OF DRAWINGS

FIGS. 1-4 show different embodiments of the presently disclosed fiber optic sensor cable.

FIG. 1A is a perspective cut-through view of a first exemplary embodiment of the sensor cable. This rectangular sensor cable (with rounded corners) comprises one centrally located optical fiber with a multimode graded index 50 μm core, a 125 μm cladding, a 250 μm coating and a 900 μm tight or semi tight buffer layer enveloped by a plastic (PVDF) jacket wherein two longitudinal strength members are incorporated on each side of the optical fiber such that the centres of the strength members and the optical fiber form a first axis perpendicular to the longitudinal axis of the cable FIG. 1B is a cross sectional illustration of the sensor cable in FIG. 1A where the dimensions of the various elements of the sensor cable in FIG. 1A are indicated.

FIG. 2A is a perspective cut-through view of a second exemplary embodiment of the sensor cable. This rectangular sensor cable (with rounded corners) comprises one centrally located optical fiber with a multimode graded index 50 μm core, a 125 μm cladding, a 250 μm coating and a 500 μm tight or semi tight buffer layer enveloped by a plastic (PVDF) jacket wherein two longitudinal metallic strength members 25 are incorporated on each side of the optical fiber such that the centres of the strength members and the optical fiber form a first axis perpendicular to the longitudinal axis of the cable.

FIG. 2B is a cross sectional illustration of the sensor cable in FIG. 2A where the dimensions of the various elements of the sensor cable in FIG. 2A are indicated.

FIG. 3A is a perspective cut-through view of a third exemplary embodiment of the sensor cable. This rectangular sensor cable (with rounded corners) comprises one centrally located optical fiber with a multimode graded index 50 μm core, a 125 μm cladding, a 250 μm coating and a 500 μm tight or semi tight buffer layer enveloped by a plastic (PVDF) jacket wherein two longitudinal metallic strength members are incorporated on each side of the optical fiber such that the centres of the strength members and the optical fiber form a first axis perpendicular to the longitudinal axis of the cable.

FIG. 3B is a cross sectional illustration of the sensor cable in FIG. 3A where the dimensions of the various elements of the sensor cable in FIG. 3A are indicated.

FIG. 4A is a perspective cut-through view of a fourth exemplary embodiment of the sensor cable. This rectangular sensor cable (with rounded corners) comprises one centrally located optical fiber with a multimode graded index 50 μm core, a 125 μm cladding, a 250 μm coating and a 500 μm tight or semi tight buffer layer enveloped by a plastic (PVDF) jacket wherein two longitudinal metallic strength members are incorporated on each side of the optical fiber such that the centres of the strength members and the optical fiber form a first axis perpendicular to the longitudinal axis of the cable.

FIG. 4B is a cross sectional illustration of the sensor cable in FIG. 3A where the dimensions of the various elements of the sensor cable in FIG. 4A are indicated.

### DETAILED DESCRIPTION OF THE INVENTION

As previously described the optical fiber(s) is preferably disposed and/or arranged in a stress free configuration in the cable. This may for example be realized by providing a slip layer between each optical fiber and the corresponding buffer layer surrounding the optical fiber. The slip layer may comprise (partly or fully) a soft filling material, such as a gel, such as a silicone gel. The slip layer may provide for a semi-tight buffering of the optical fiber. A slip layer may help to ensure that the optical fiber can be easily stripped from the buffering. The slip layer is very thin, e.g. the width of the slip layer may be less than 50 micron, or less than 30 micron, or less than 20 micron, or less than 15 micron, or less than 10 micron, or less than 5 micron.

As previously stated the plastic jacket is preferably a thermoplastic jacket provided in a thermoplastic polymer, preferably a thermoplastic fluoropolymer such as polyvinylidene difluoride (PVDF). This provides a sufficient resistance to high temperatures.

The buffer layer may be a hard or soft plastic material, such as a thermoplastic material. The buffer layer may be between 200 and 2000 μm in diameter, more preferably between 400 and 900 μm in diameter, such as 400 μm, 500 μm or 900 μm buffer layers.

The strength members may advantageously be provided in a metal or metal alloy, such as stainless steel. Preferably each strength member is a wire such as a metal wire, such as a steel wire, such as a stainless steel wire, such as stainless steel wire type 316SS. Each strength member may have a substantially circular cross-section. The maximum diameter or each strength member may be between 0.1 and 1 mm, or between 0.2 and 0.8 mm, or between 0.3 and 0.7 mm, or between 0.4 and 0.6 mm, such as 0.5 mm.

In the preferred embodiment of the presently disclosed sensor cable the length of the optical fiber(s) inside the sensor cable correspond to the length of the sensor cable, i.e. preferably there is no excess length of optical fiber inside the cable as is typically known from fiber optic transmission cables.

One way to provide for a stress free configuration of the optical fiber(s) and a kink free configuration of the cable is to arrange the strength members such their centres are generally aligned with the centre(s) of the optical fiber(s). The centres of the strength member and the centre(s) of the optical fiber(s) thereby forming a first axis of the sensor cable. The sensor cable will thereby be substantially kink free if tension is applied along this first axis.

The relative positions of the buffer layers(s) and the strength members are preferably symmetric in the jacket. With a sensor cable with one optical fiber, the optical fiber is preferably located in the centre if the jacket with the strength members on each side located equidistant from the buffer layer.

The buffer layer may be located at a certain distance from each strength member such that jacket material separates the buffer layer(s) and the strength members. Alternatively the strength members are located adjacent to, in contact with and on opposite sides of the buffer layer, i.e. the strength members are abutting the buffer layer on opposite sides.

All though the sensor cable must be strong, another issue of the cable is the size, i.e. the foot print, because space is limited if the purpose is incorporation into the design of a flexible pipe. The width of the jacket of the presently disclosed sensor cable along the first axis is therefore preferably less than 10 mm, more preferably less than 5 mm, or less than 4 mm, or equal to 3.5 mm, or less than 3 mm, or equal to or less than 2.5 mm.

In a further embodiment the width of the jacket along the first axis is larger than the width of the jacket along a second axis perpendicular to the first axis. Consequently the width of the jacket along a second axis perpendicular to the first axis may be less than 10 mm, or less than 5 mm, or less than 4 mm, or equal to 3.5 mm, or less than 3 mm, or less than or equal to 2 mm.

In an alternative embodiment the width of the jacket along the first axis is less than the width of the jacket along a second axis perpendicular to the first axis.

In principle the cross-section of the jacket may be provided in any shape, because the plastic jacket can be moulded into any shape during manufacture of the cable. However, one preferred embodiment is a generally rectangular shape of the jacket, i.e. the cross section of the jacket is generally rectangular, such that the sensor cable can be easily integrated in for example a void or a groove of a flexible tube.

A rectangular shape of the jacket further has the advantage that twist of the sensor cable is easily controlled during handling. For a sensor cable it is important to reduce twist during handling and installation to an absolute minimum because twist may introduce strain the cable which may be transferred to the optical fiber inside the sensor cable. A substantially rectangular shape of the cable ensures that the sensor cable in itself is more reluctant to twist during handling and installation, but a rectangular shape also ensures that orientation of the cable can be monitored because the various axes of a rectangular sensor cable can be visually identified in contrast to e.g. a circular cable. Other cross-sectional shapes are possible where the similar technical effect can be obtained, e.g. with top side and/or a bottom side of the sensor cable being substantially plane or an elongated shape, e.g. along the axis formed by the strength members.

A generally rectangular shape may also increase the contact area between the sensor cable and for example a flexible tube such that the temperature of the flexible tube is more efficiently transferred to the sensor cable. The cross-sectional shape of the jacket may however be provided with rounded corners, e.g. a rectangular shape with rounded corners.

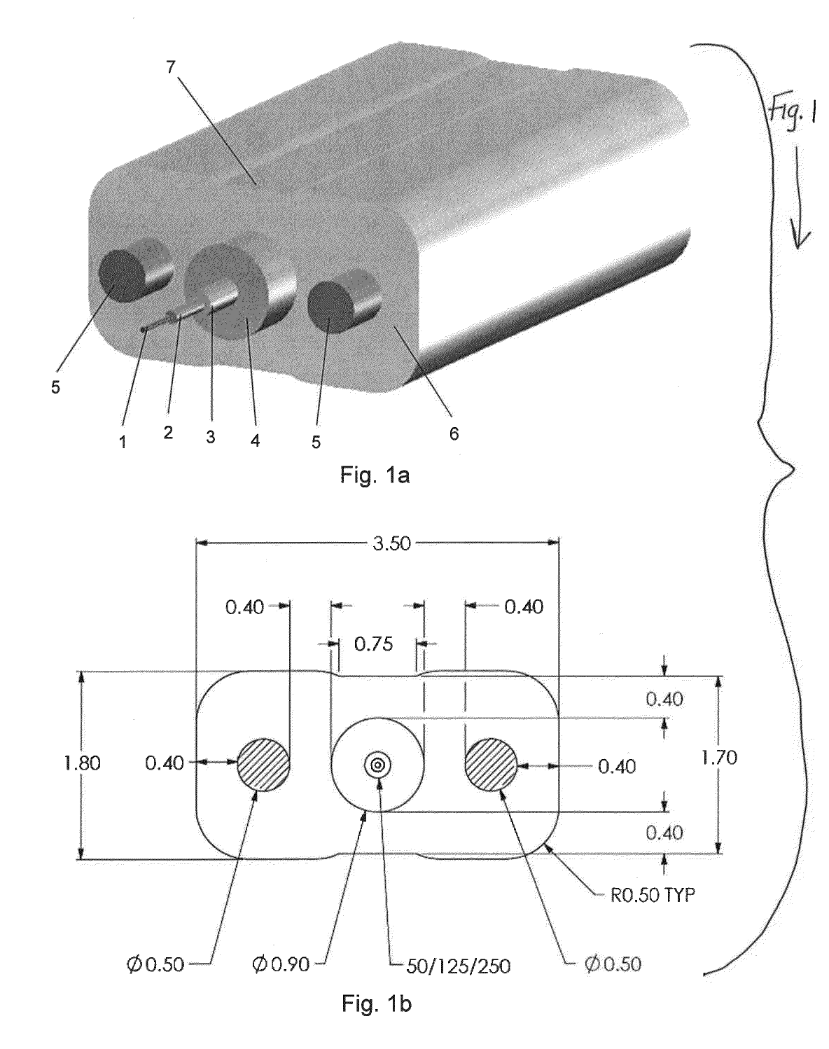

In a further embodiment of the sensor cable with a rectangular cross section, the top and/or the bottom of the jacket comprises one or more recessions. These recessions are provided to reduce the amount of jacket material surrounding the buffer layer(s). A temperature difference in the air surrounding the sensor cable may then more quickly be transferred to the optical fiber and can thereby be detected. A recession in the top and/or the bottom of the jacket may be formed as a central linear cut-out parallel to an axis formed by the positions of the strength members, as exemplified in FIGS. 1-4.

The optical fiber(s) inside the sensor cable may be single mode or multimode, whatever is appropriate for the sensor system. The optical fiber may be standard size with 125 μm cladding and 250 μm coating. The innermost coating layer may comprise a thin Angstrom wide layer of carbon to provide additional protection against hydrogen ingression.

### Systems Employing Fiber Optic Sensor Cable

A further aspect of the present disclosure relates to a remote sensing system using the here disclosed fiber optic sensor cable. Hence, one embodiment relates to a fiber optic remote sensing system comprising at least one fiber optic sensor cable as disclosed herein, at least one light source and at least one receiver. The remote sensing system may be configured such that light from said light source is emitted into an optical fiber of said fiber optic sensor cable and such that light transmitted in and/or backscattered from said optical fibre is detected by said receiver. A processing unit may be provided as a part of the remote sensing system and configured to process the signal received by the receiver and determine variations in the ambient conditions, such as temperature, pressure, strain, along at least a part of the length of fiber optic sensor cable.

A further embodiment relates to a distributed temperature sensing system comprising at least one fiber optic sensor cable as disclosed herein, and a controller comprising least one light source, at least one receiver and a processing unit, the controller configured to such that light from the light source is modulated and transmitted through the fiber optic sensor cable, and such that the backscattered signal is detected and processed in order to determine variations in temperature along the length of the fiber optic sensor cable.

Remote and distributed sensing systems are known in the art and the skilled person would know how to install and operate such systems. However, the presently disclosed fiber optic sensor cable makes it possible to have the presently claimed sensing systems as part of a flexible transport path, e.g. a flexible tube, i.e. the a fiber optic sensor cable which is part of a sensing system may be installed and/or incorporated in a flexible transport path and the remote sensing system can thereby detect variations in the ambient conditions of the flexible transport path.

A further aspect of the present disclosure relates to a transport line/path in the form of e.g. a duct or tube or pipe or the like, possibly flexible, incorporating one or more of the herein disclosed fiber optic sensor cables. The transport line may comprise one or more closed pipelines wherein e.g. fluid can be transported. The fiber optic sensor cable may be incorporated in the transport line such that the optical fiber(s) in the sensor cable is disposed in stress free configuration, even if the transport line is flexible. This ensures that the optical fiber(s) in the sensor cable can be used for remote sensing of the transport line, i.e. sensing temperature, pressure and/or strain of the transport line itself, of the ambient conditions of the transport and/or of the content of the transport line, e.g. a fluid in the transport line. Remote sensing may be provided by incorporating the optical fiber(s) in a remote sensing system as described above.

### EXAMPLES

Various designs of the presently disclosed sensor cable are illustrated in FIGS. 1-4.

FIG. 1A is a perspective cut-through view of one embodiment of the sensor cable. The rectangular sensor cable (with rounded corners) comprises one centrally located optical fiber with a multimode graded index 50 μm core 1, the 125 μm cladding 2, the 250 μm coating 3 and a 900 μm tight or semi tight buffer layer 4. The buffer layer 3 is enveloped by a plastic (PVDF) jacket 6 wherein two longitudinal strength members 5 are incorporated on each side of the optical fiber such that the centres of the strength members and the optical fiber form a first axis perpendicular to the longitudinal axis of the cable. The cross section of the jacket 6 is rectangular with rounded corners having central recessions 7 in the top and bottom of the jacket, wherein the widths of the recessions 7 are aligned with and matching the width of the buffer layer 4. The slip layer between the coating of the optical fiber and the buffer layer is not visible.

FIG. 1B is a cross sectional illustration of the sensor cable in FIG. 1A where the dimensions of the various elements are indicated in mm (however in μm for the optical fiber marked as 50/125/250 for the core/cladding/coating). The width of the cable jacket 6 is 3.5 mm whereas the height is 1.8 mm. The two recessions 7 are each 0.9 mm wide corresponding to the diameter of the buffer layer 4. The two strength members 5 are steel wires with a diameter of 0.5 mm and they are located 0.4 mm from the edge of the jacket. The recessions are 0.1 mm deep. This configuration provides a minimum of 0.4 mm of jacket material around the strength members and the buffer layer.

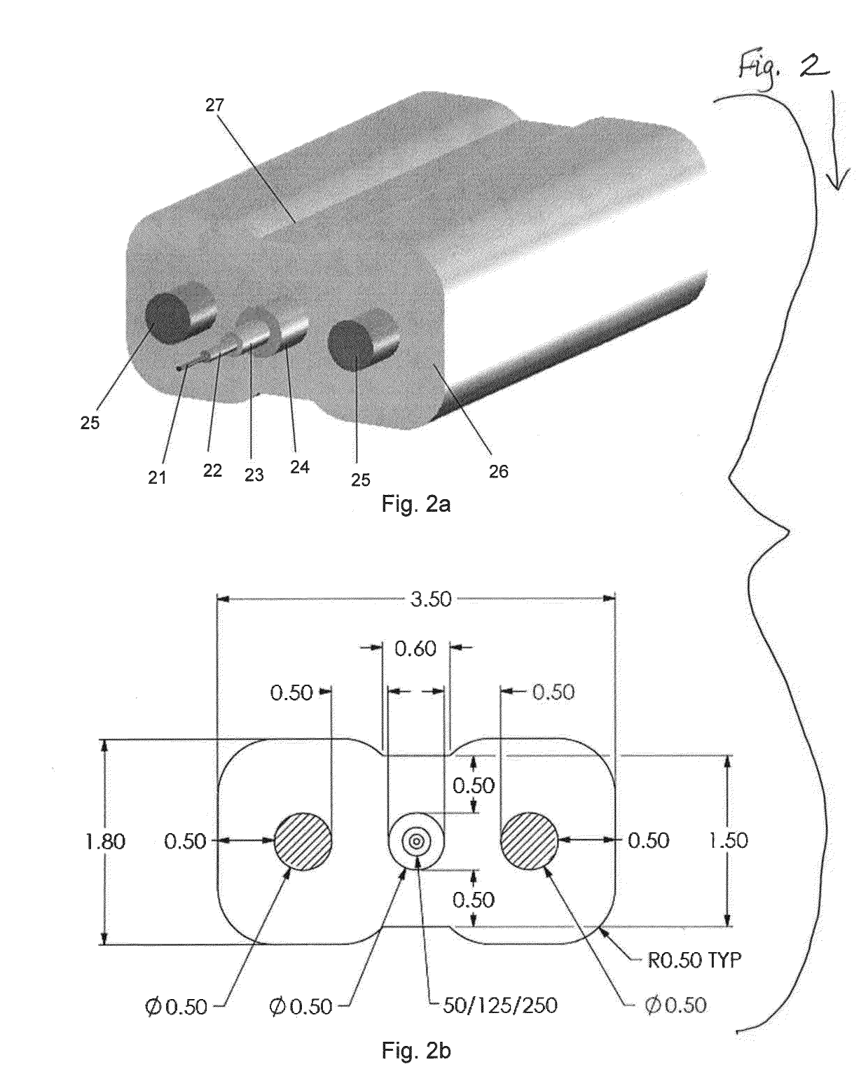

FIG. 2A is a perspective cut-through view of another embodiment of the sensor cable. The rectangular sensor cable (with rounded corners) comprises one centrally located optical fiber with a multimode graded index 50 μm core 21, the 125 μm cladding 22, the 250 μm coating 23 and a 500 μm tight or semi tight buffer layer 24. The buffer layer 23 is enveloped by a plastic (PVDF) jacket 26 wherein two longitudinal metallic strength members 25 are incorporated on each side of the optical fiber such that the centres of the strength members and the optical fiber form a first axis perpendicular to the longitudinal axis of the cable. The cross section of the jacket 26 is rectangular with rounded corners having central recessions 27 in the top and bottom of the jacket, wherein the widths of the recessions 27 are aligned with the buffer layer 24. The slip layer between the coating of the optical fiber and the buffer layer is not visible.

FIG. 2B is a cross sectional illustration of the sensor cable in FIG. 2A where the dimensions of the various elements are indicated in mm (however in μm for the optical fiber marked as 50/125/250 for the core/cladding/coating). The width of the cable jacket 26 is 3.5 mm whereas the height is 1.8 mm. The two recessions 27 are each 0.6 mm wide almost corresponding to the diameter of the buffer layer 24. The two strength members 25 are steel wires with a diameter of 0.5 mm and they are located 0.5 mm from the edge of the jacket. The recessions are 0.3 mm deep. Hence, the embodiment in FIGS. 2A and 2B differs from the design in FIGS. 1A and 1B in that the buffer layer is only 500 μm in diameter and that the width of the recessions is 0.6 mm, i.e. slightly larger than the diameter of the buffer layer, and that the depth of the recession is 0.3 mm, i.e. slightly more than the design in in FIGS. 1A and 1B. Due to the smaller buffer layer the elements in FIGS. 2A and 2B can be arranged such that a minimum of 0.5 mm of jacket material surrounds the strength members and the buffer layer.

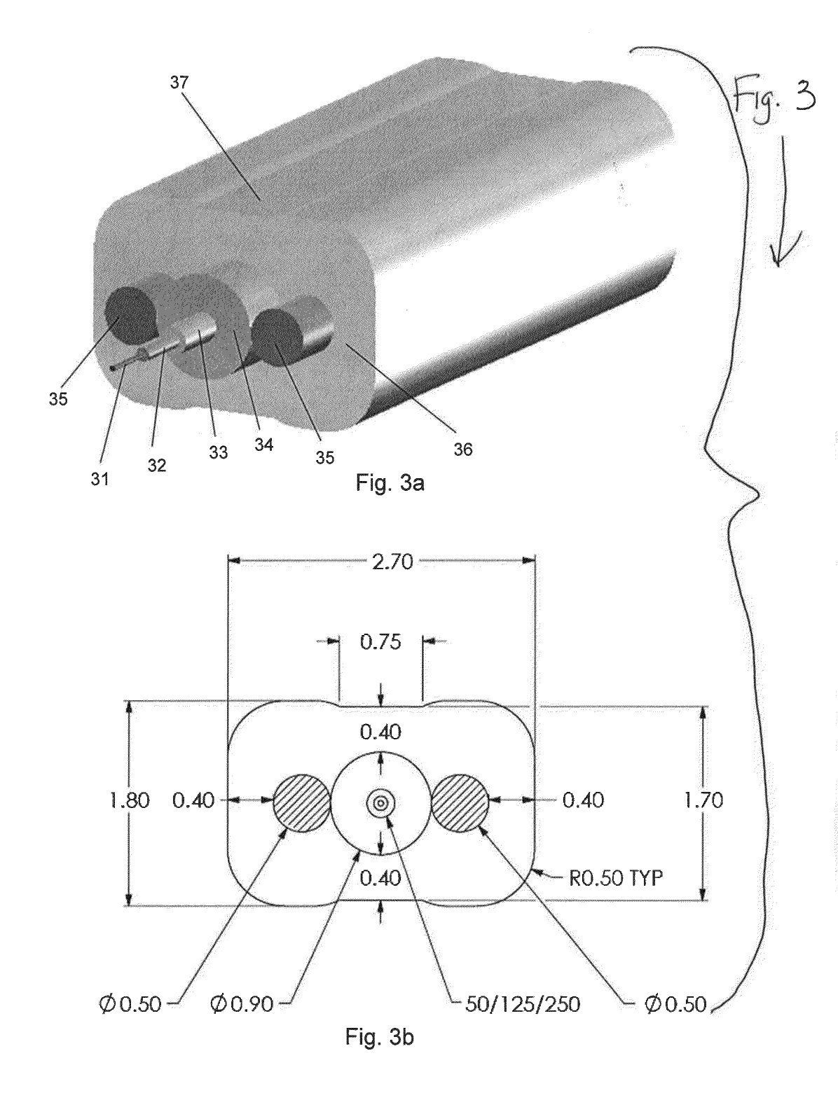

FIG. 3A is a perspective cut-through view of another embodiment of the sensor cable. The rectangular sensor cable (with rounded corners) comprises one centrally located optical fiber with a multimode graded index 50 μm core 31, the 125 μm cladding 32, the 250 μm coating 33 and a 900 μm tight or semi tight buffer layer 34. The buffer layer 33 is enveloped by a plastic (PVDF) jacket 36 wherein two longitudinal metallic strength members 35 are incorporated on each side of the optical fiber such that the centres of the strength members and the optical fiber form a first axis perpendicular to the longitudinal axis of the cable. The cross section of the jacket 36 is rectangular with rounded corners having central recessions 37 in the top and bottom of the jacket. The slip layer between the coating of the optical fiber and the buffer layer is not visible.

FIG. 3B is a cross sectional illustration of the sensor cable in FIG. 3A where the dimensions of the various elements are indicated in mm (however in μm for the optical fiber marked as 50/125/250 for the core/cladding/coating). The width of the cable jacket 36 is 2.7 mm whereas the height is 1.8 mm. The two recessions 37 are each 0.75 mm wide. The two strength members 35 are steel wires with a diameter of 0.5 mm and they are located 0.4 mm from the edge of the jacket, however abutting the buffer layer 34 of the optical fiber. The recessions are 0.1 mm deep. Hence, the embodiment in FIGS. 3A and 3B differs from the design in FIGS. 1A and 1B in that the strength members 35 are abutting the buffer layer 34 on opposite sides of the buffer layer. In FIGS. 3A and 3B the dimensions of the strength members, the buffer layer, the recession and the height of the jacket are similar to the design illustrated in FIGS. 1A and 1B. However, due to the strength members 35 and the buffer layer 34 abutting each other, the width of the jacket (and thereby the width of the sensor cable) can be reduced to 2.7 mm. There is still a minimum of 0.4 mm of jacket material surrounding the buffer layer and the strength members.

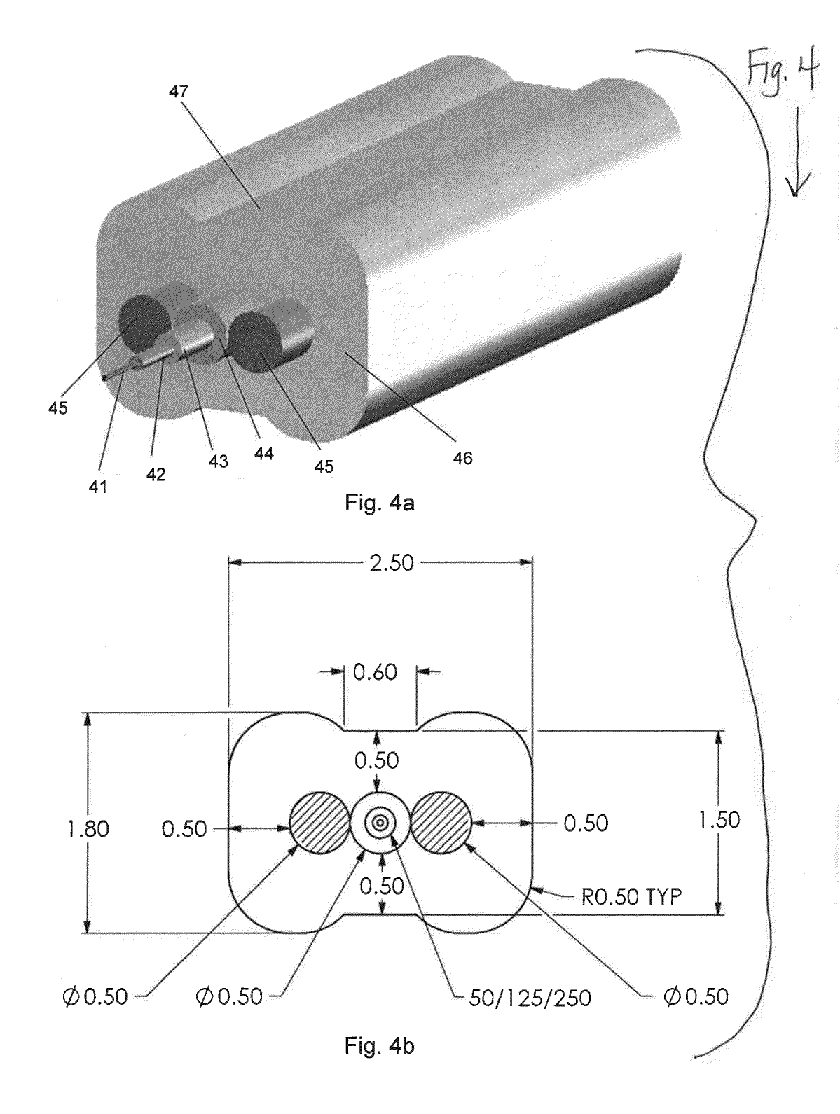

FIG. 4A is a perspective cut-through view of another embodiment of the sensor cable. The rectangular sensor cable (with rounded corners) comprises one centrally located optical fiber with a multimode graded index 50 μm core 41, the 125 μm cladding 42, the 250 μm coating 43 and a 500 μm tight or semi tight buffer layer 44. The buffer layer 43 is enveloped by a plastic (PVDF) jacket 46 wherein two longitudinal metallic strength members 45 are incorporated on each side of the optical fiber such that the centres of the strength members and the optical fiber form a first axis perpendicular to the longitudinal axis of the cable. The cross section of the jacket 46 is rectangular with rounded corners having central recessions 47 in the top and bottom of the jacket. The slip layer between the coating of the optical fiber and the buffer layer is not visible.

FIG. 4B is a cross sectional illustration of the sensor cable in FIG. 4A where the dimensions of the various elements are indicated in mm (however in μm for the optical fiber marked as 50/125/250 for the core/cladding/coating). The width of the cable jacket 46 is 2.5 mm whereas the height is 1.8 mm. The two recessions 47 are each 0.6 mm wide.

The two strength members 45 are steel wires with a diameter of 0.5 mm and they are located 0.5 mm from the edge of the jacket, however abutting the buffer layer 44 of the optical fiber. The recessions are 0.3 mm deep. Hence, the embodiment in FIGS. 4A and 4B differs from the design in FIGS. 3A and 3B in that the buffer layer is only 500 μm in diameter and that the width of the recessions is 0.6 mm, i.e. slightly larger than the diameter of the buffer layer, and that the depth of the recession is 0.3 mm, i.e. slightly more than the design in in FIGS. 3A and 3B. Due to the reduced diameter of the buffer layer and with strength members 45 and the buffer layer 44 abutting each other, the width of the jacket (and thereby the width of the sensor cable) can be reduced to 2.5 mm. There is still a minimum of 0.5 mm of jacket material surrounding the buffer layer and the strength members, i.e. slightly more than in the design illustrated in FIGS. 3A and 3B. The design illustrated in FIGS. 4A and 4B therefore has the smallest footprint with a maximum width of the cable of only 2.5 mm.

1. A fiber optic sensor cable comprising
one or more optical fibers, each optical fiber comprising at least one core for guiding light, at least one cladding layer and one or more coating layers,
at least one thermoplastic buffer layer surrounding each optical fiber,
two or more longitudinally extending strength members located on opposite sides of the buffer layer(s), and
a thermoplastic jacket enveloping the buffer layer(s) and the strength members, wherein the cross-section of the thermoplastic jacket has a generally rectangular shape.

2. The fiber optic sensor cable according to claim 1, further comprising a slip layer between each optical fiber and the corresponding buffer layer surrounding the optical fiber, wherein the slip layer comprises a soft filling material

3. The fiber optic sensor cable according to claim 2, wherein the width of the slip layer is less than 20 micron, or less than 5 micron.

4. The fiber optic sensor cable according to claim 1, wherein the buffer layer surrounding an optical fiber forms a semi-tight buffer layer such that each optical fiber is arranged in a stress-free configuration in the buffer layer.

5. The fiber optic sensor cable according to claim 1, wherein the thermoplastic jacket and the thermoplastic buffer layer are provided in polyvinylidene difluoride (PVDF).

6. The fiber optic sensor cable according to claim 1, wherein each optical fiber comprises a carbon layer surrounding the cladding layer(s) between the outermost cladding layer and the innermost coating layer.

7. The fiber optic sensor cable according to claim 1, wherein each strength member is a metal wire with a circular cross-section.

8. The fiber optic sensor cable according to claim 1, wherein the maximum diameter or each strength member is between 0.3 and 0.7 mm, or between 0.4 and 0.6 mm, or 0.5 mm.

9. The fiber optic sensor cable according to claim 1, wherein the length of the optical fiber(s) inside the sensor cable corresponds to the length of the sensor cable.

10. The fiber optic sensor cable according to claim 1, wherein the centres of the strength members are generally aligned with the centre(s) of the optical fiber(s) forming a first axis of the sensor cable.

11. The fiber optic sensor cable according to claim 10, wherein the width of the jacket along the first axis is less than 5 mm, or less than 4 mm, or equal to 3.5 mm, or less than 3 mm, and wherein the width of the jacket along the first axis is larger than the width of the jacket along a second axis perpendicular to the first axis.

12. The fiber optic sensor cable according to claim 10, wherein the width of the jacket along a second axis perpendicular to the first axis is less than 5 mm, or less than 4 mm, or equal to 3.5 mm, or less than 3 mm, or less than or equal to 2 mm.

13. The fiber optic sensor cable according to claim 1, wherein the cross-section of the jacket has a generally rectangular shape with rounded corners.

14. The fiber optic sensor cable according to claim 10, wherein the top or the bottom of the jacket comprises one or more recessions adapted to reduce the amount of jacket material surrounding the buffer layer(s).

15. The fiber optic sensor cable according to claim 10, further comprising at least one recession in the top or the bottom of the jacket formed as a central linear cut-out parallel to an axis formed by the positions of the strength members.

16. The fiber optic sensor cable according to claim 1, wherein the buffer layers(s) is located a predefined distance from each strength member such that jacket material separate the buffer layer(s) and the strength members.

17. The fiber optic sensor cable according to claim 1, wherein the strength members are located adjacent to, in contact with and on opposite sides of the buffer layer.

18. A fiber optic remote sensing system comprising at least one fiber optic sensor cable according to claim 1, at least one light source and at least one receiver, the system configured such that light from said light source is emitted into an optical fiber of said fiber optic sensor cable and such that light transmitted in or backscattered from said optical fibre is detected by said receiver.

19. The fiber optic remote sensing system according to claim 18, further comprising a processing unit configured to process the signal received by the receiver and determine variations in the ambient conditions in relation to temperature, pressure or strain, along at least a part of the length of fiber optic sensor cable.

20. A distributed temperature sensing system comprising at least one fiber optic sensor cable according to claim 1, and a controller comprising least one light source, at least one receiver and a processing unit, the controller configured such that light from the light source is modulated and transmitted through the fiber optic sensor cable, and such that the backscattered signal is detected and processed in order to determine variations in temperature along the length of the fiber optic sensor cable.
